(19) United States
(12) Patent Application Publication
(10) Pub. No.: US 2016/0080488 A1
(43) Pub. Date: Mar. 17, 2016

(54) IMPLEMENTING FILE-BASED PROTOCOL FOR REQUEST PROCESSING

(71) Applicant: Microsoft Corporation, Redmond, WA (US)

(72) Inventors: Roopesh Battepati, Bellevue, WA (US); Ziquan Zhu, Bellevue, WA (US); Raymond Wang, Kirkland, WA (US); Ganesh Prasad, Bellevue, WA (US)

(73) Assignee: Microsoft Corporation, Redmond, WA (US)

(21) Appl. No.: 14/484,532

(22) Filed: Sep. 12, 2014

(51) Int. Cl. H04L 29/08

(52) U.S. Cl. CPC H04L 67/1095

(57) ABSTRACT

Examples of the present disclosure describe implementations of a file-based protocol for request processing. A request, sent from a first device, may be received at a second device using a file-based transport protocol as a transport service. The request may be processed by the second device using a virtual file system, which implements a transport layer to interface with the file-based transport protocol. The transport layer of the virtual file system may be utilized to receive, evaluate and process transmissions from the file-based transport protocol. The virtual file system may forward a response to the file-based transport protocol for transmission to the first device. Other examples are also provided.

### BACKGROUND

Data replication systems use network protocols to communicate replication information. Generally, an application-specific Internet Protocol (IP) or Fibre Channel (FC) protocol is used to communicate replication information. It is with respect to this general technical environment that the present application is directed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Examples of the present disclosure describe implementations of a file-based protocol for request processing. A request, sent from a first device, may be received at a second device using a file-based transport protocol as a transport service. The request may be processed by the second device using a virtual file system, which implements a transport layer to interface with the file-based transport protocol. The transport layer of the virtual file system may be utilized to receive, evaluate and process transmissions from the file-based transport protocol. The virtual file system may forward a response to the file-based transport protocol for transmission to the first device. The virtual file system may be further usable to provide added capability such as managing access control and connection loss detection with the file-based transport protocol, among other examples.

Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of a system that may be used to implement examples described herein.

FIG. 2A illustrates a virtual file system example as described herein.

FIG. 2B illustrates an operational flow of request and response processing as described herein.

FIG. 3 illustrates an operational flow for request and response processing as described herein.

FIG. 4A is an operational flow for examples of processing performed by a virtual file system as described herein.

FIG. 4B is an operational flow of example capabilities of a virtual file system as described herein.

FIG. 5 is a block diagram illustrating an example of a computing device with which aspects of the present disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

### DETAILED DESCRIPTION

Examples of the present disclosure provide implementations of a file-based protocol for request processing. Implementation of a file-based protocol provides added capability compared with an application-specific protocol. For example, a file-based protocol may enable capabilities such as enterprise security management, multi-channel connection processing, remote direct memory access (RDMA), encryption, signing, and continuous availability, among others. A virtual file system may be implemented to interface with the file-based protocol at a transport layer in order to utilize the file-based protocol for request processing. This can improve processing of requests when using a file-based protocol. Further, examples of the present disclosure provide added capabilities, whereby capabilities such as access control and connection loss detection can be implemented.

Examples of the present disclosure describe implementations of a file-based protocol for request processing. A request, sent from a first device, may be received at a second device using a file-based transport protocol as a transport service. The request may be processed by the second device using a virtual file system, which implements a transport layer to interface with the file-based transport protocol. The transport layer of the virtual file system may be utilized to receive, evaluate and process transmissions from the file-based transport protocol. The virtual file system may forward a response to the file-based transport protocol for transmission to the first device.

As an example, a request can be for data replication such as a request for processing a remote data write. However, the present disclosure can relate to any request for any information transmittable between two devices. Examples of devices in which data replication requests may be performed include a source machine and a target machine. In alternative examples, a request may be sent to more than one device for processing. For example, a source machine may request data replication on a number of target machines. Requests may be sent to each of the target machines and the source machine may receive responses from each target machine.

A file-based transport protocol may be used as a transport service for communicating between devices. Examples of file-based transport protocol include but are not limited to Network File System (NFS), Server Message Block (SMB), Apple Filing Protocol (AFP), and Network Control Program (NCP). Furthermore, the present disclosure is not limited to using a single file-based transport protocol and may utilize multiple file-based protocols to implement a transport service between devices. Moreover, it should be understood that the present disclosure is implementable with different iterations of a file-based protocol. When using SMB as an example, the present disclosure may be implementable with any iteration of Server Message Block (SMB) protocol, including SMB 2.0 or SMB 3.0, among other protocols.

When considering transport of information for request processing, a transport layer is provided to support processing of a request. In an example where a request is for data replication, a file-based transport protocol may lack capability for directing and processing information for a data replication request. Additional steps may need to be taken to receive, evaluate and process a request for data replication.

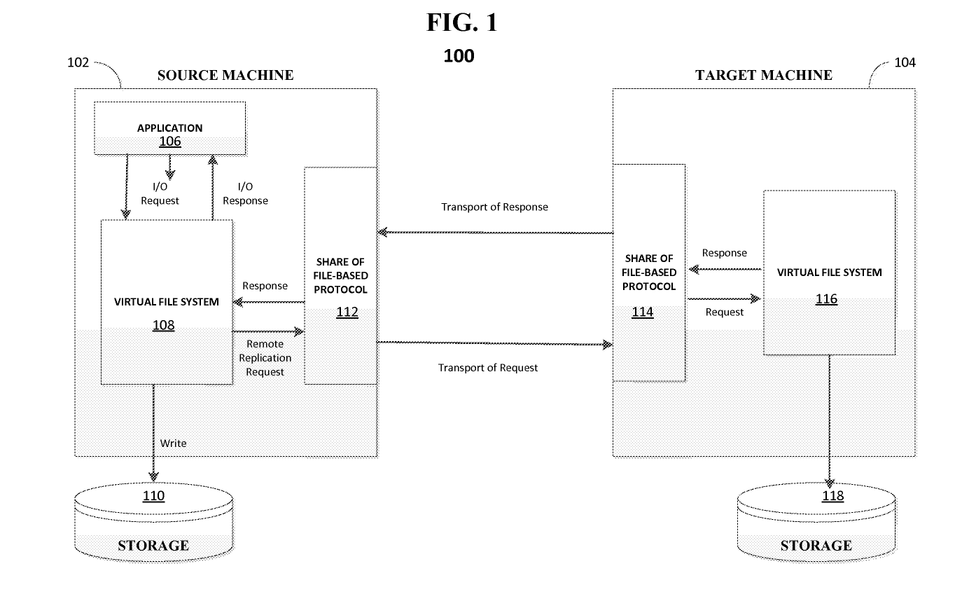

FIG. 1 illustrates an overview of a system 100 that may be used to process a request. An application 106, operating on a source machine 102, may send a request for data processing and replication. The request may be related to any type of data replication between multiple devices. For example, the request may be a request for writing data to a storage 110 of the source machine 102 and performance of a remote replication request on at least one target machine 104. The application 106 may forward an input/output (I/O request) to a virtual file system 108. In the example where a request is for a write and remote replication, the virtual file system 108 may perform a data write to the storage 110 of the source machine 102, and forward the request to a connection share 112 of file-based transport protocol, which is used to transmit a replication request to the target machine 104.

A file-based protocol connection share 112 may be implemented on a source machine 102 and a file-based protocol connection share 114 may be implemented on the target machine 104. Using respective connection shares 112 and 114, a communication channel may be established between the source machine 102 and the target machine 104. In one example, file-based protocol connection shares may be direct. However, in alternative examples, connection shares for multiple devices may be connected using the file-based transport protocol. Request and response data may be transmitted between devices using a communication channel of the file-based transport protocol.

Continuing with the example where the replication request is received at the file-based protocol connection share 112, the request is transmitted to the file-based protocol connection share 114 of the target machine 104. The request is then forwarded to a virtual file system 116 of the target machine 104 for processing. Data transported via the file-based transport protocol may need to be modified for replication to occur on the target machine 104. The virtual file system 116 may evaluate and process transmission data received from the file-based transport protocol to perform data replication on the storage 118 of the target machine 104.

After the data replication request is sent to the storage 118, the virtual file system 116 will process a response to the request. The processed response is forwarded to the file-based protocol connection share 114 on the target machine 104. From there, the file-based transport protocol transmits the response to the file-based protocol connection share 112 on the source machine 102. The file-based protocol connection share 112 on the source machine 102 forwards the response to the virtual file system 108 of the source machine 102 for processing. The virtual file system 108 transmits an I/O response to the application 106 with respect to the original I/O request.

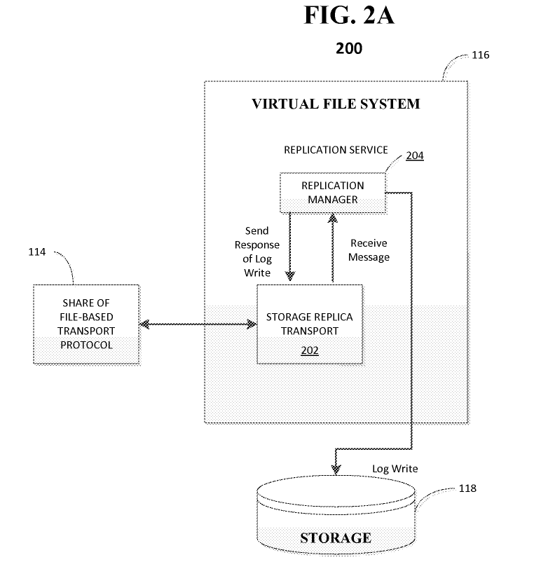

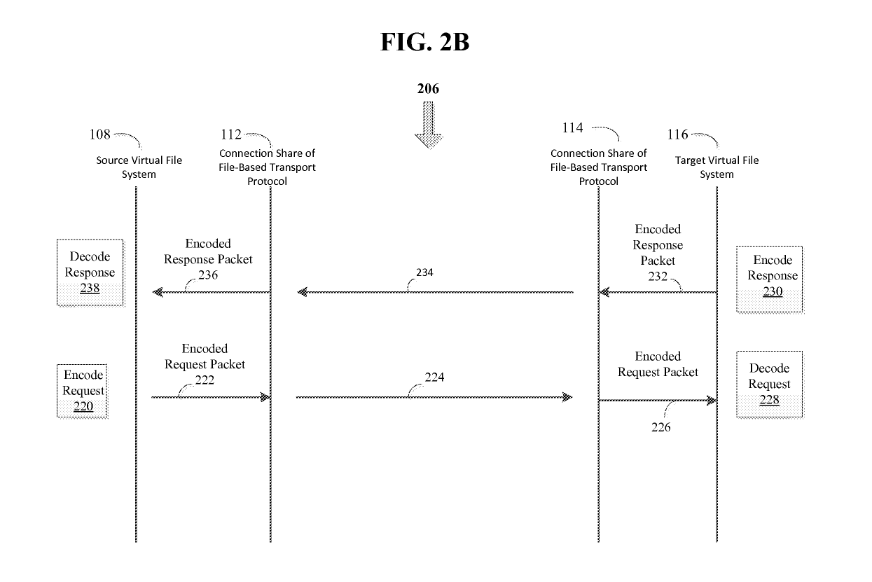

FIG. 2A illustrates a virtual file system 200 example as described herein. For ease of understanding, the virtual file system 200 is shown as the virtual file system 116 of the target machine 104 (as described in FIG. 1). However, it should be understood that the virtual file system 200 described can be applicable to any device, including a source machine such as the source machine 102 referenced in FIG. 1. The virtual file system 116 may register itself to the file-based protocol connection share 114. The virtual file system 116 may communicate directly with the file-based protocol connection share 112 of the source machine 102 to receive requests. Requests may be automatically forwarded to the virtual file system 116 for processing when requests are transmitted from the file-based transport protocol from the source machine 102 to the file-based protocol connection share 114. In one example, the virtual file system 116 may include a storage replica transport 202 and a replication manager 204.

The storage replica transport 202 is implemented at a transport layer to interface with the file-based transport protocol at a target machine 104. The storage replica transport 202 may be usable to send, receive, evaluate and process transmissions of the file-based transport protocol. As an example, the storage replica transport 202 may receive data transmissions from the file-based transport protocol and process the transmissions into a single message to provide to a replication manager 204. The storage replica transport 202 of the target machine 104 may also be used to process and encode a response to the request, for transmission back to a source machine 102.

The replication manager 204 may include a replication engine to perform data replication on the storage 118 of the target machine 104. In one example, the request received is a data replication request for a log write. A log write may occur on a source machine 102 then be replicated on any of a plurality of target machines, such as target machine 104. Once, the replication manager 204 receives the request message from the storage replica transport 202, the replication request may be processed on the storage 118. The replication manager 204 then sends a response to the storage replica transport 202. In one example, the response may include indication that successful processing of a replication was performed. In other examples, the storage replica transport 202 may communicate with the replication manager 204 to determine a status of the request, for example, if it was not completed successfully.

As identified above, the storage replica transport 202 also communicates with the file-based transport protocol, for example via a connection share 114 established on the target machine 104. Once a response to the request is received from the replication manager 204, the storage replica transport 202 may encode the response as an I/O packet and forward the I/O packet to the file-based protocol connection share 114 for transmission to another device such as a source machine 102.

In further examples, a source machine 102 may also include a virtual file system 108 (as referenced in FIG. 1). The virtual file system 108 may also include a storage replica transport (e.g., storage replica transport 202) and a replication manager (e.g, replication manager 204). A source storage replica transport may be usable to send receive, evaluate and process transmissions of the file-based transport protocol. For example, when a request may be processed and encoded by a source storage replica transport and forwarded to the connection share 112 of the file-based transport protocol for transport to the target machine 104. A source transport protocol may also be configured to receive and decode response messages transmitted from a target machine 104. The replication manager of the source may be used to provide the response to an application that made the request, for example, as an I/O response.

The storage replica transport 202 may possess capability to evaluate types of requests. Examples of types of requests which the virtual file system 116 may determine as processable can include but are not limited to write requests, read requests, file system control requests, connection establishment requests, directory control, query information, disconnection and connection close events, among others. Requests can also be denied by the storage replica transport 202. In that instance, the storage replica transport 202 can communicate with the file-based transport protocol to notify an application that a request cannot be completed.

In an example where SMB is used as the file-based transport protocol, the virtual file system 116 backs the file-based protocol connection share 114 on a target machine. The file-based protocol connection share 114 can be configured to accept incoming requests transmitted via I/O request packets (IRP). As one example, a type of request that may be handled by the virtual file system is data copy request, such as an IRP_MJ_WRITE. The virtual file system 116 backing the file-based protocol connection share 114 invokes the storage replica transport 202 of the target machine 104 to evaluate, decode data from a buffer of the request. Examples of exemplary instructions/commands that a virtual file system can process when SMB is implemented as the file-based transport protocol include:

Handling IRP_MJ_CREATE
Store Storage Replica Transport (SRT) connection object in FsContext2 field of file object.
If local SRT is not the initiator of the connection, SRT will connect back. Otherwise, just complete the IRP with STATUS_SUCCESS.

Handling IRP_MJ_DIRECTORY_CONTROL
Just pend this IRP.

Handling IRP_MJ_CLEANUP
Remove SRT connection object from FsContext2.

Handling IRP_MJ_FILE_SYSTEM_CONTROL
Pend this IRP and create workitem to process replication request carried by this IRP. After it is completed, this IRP will be completed.

Handling IRP_MJ_WRITE
Copy the data from this IRP, and complete it. Data is handed over to reassemble logic and final reconstructs into replication messages.

The storage replica transport 202 may encode and decode data into request/response packets. The storage replica transport 202 may decode packet data received from the file-based transport protocol to be able to properly process a request such as a data replication request. Additionally, the storage replica transport 202 may encode control data into a response to a request before forwarding the response to a connection share of the file-based transport protocol, so that a response can be properly processed by a virtual file system existing on another device, such as a source machine 104 as referenced in FIG. 1. In another example where a storage replica transport is utilized to initiate a request, that storage replica transport may be used to encode control data into a request for proper replication processing by a virtual file system on another device. A storage replica transport that is utilized to initiate a request, also decodes a response received.

With respect to processing of request packets, the storage replica transport 202 may receive a plurality of packets from the file-based transport protocol. In order to process the plurality of packets, the storage replica transport 202 may decode a request/response by implementing re-transmission detection logic and message re-assembly logic. This enables transformation of the plurality of request packets back into a single request message that can be interpreted by the replication manager 204. For example, a file-based protocol may be allowed to chunk buffer a request into smaller pieces and retransmit a same piece of data multiple times. Without applying message re-transmission logic and message re-assembly logic, a replication engine of the virtual file system 116 may receive multiple request data belonging to a same request. In examples, because typical application-specific replication transport protocols do not allow chunking and retransmission, replication manager 204 may not be able to process data for replication. Additionally, the possibility is present that request data may be received out of order and thus unable to be processed correctly by a replication engine. The storage replica transport 202 can be used to bridge the communication gap between a file-based transport protocol and a replication engine. Refer to the description of FIG. 2B below for a more detailed explanation.

FIG. 2B illustrates an operational flow 206 of request and response processing. In an example, the operational flow 206 may be applicable to process data replication communication interaction between a source machine and a target machine. A virtual file system may be created on each of a source machine and a target machine to enable use of the file-based transport protocol for data replication. A virtual file system on either of the source machine or the target machine may implement transport algorithms to enable use of a file-based transport protocol for data replication. The transport algorithms may be used to enable share creation of the file-based transport protocol, connection establishment and close, connection loss detection, access control and data transmission, among other examples. As an example, FIG. 2B illustrates request processing between a source virtual file system 108 and a target virtual file system 116. Although, the flow diagram 206 of FIG. 2B is described with reference to components of system 100, it will be apparent that the operations may be used by other systems and individual components.

The source virtual file system 108 (created on a device such as the source machine 102 in FIG. 1) may receive a data replication request sent by an application such as the application 106 as described in FIG. 1. The source virtual file system 108 may establish a connection share 112 of the file-based transport protocol, and the target virtual file system 116, for example created on the target machine 104 of FIG. 1, may also establish a connection share 114 of the file-based transport protocol. The source virtual file system 108 may bind itself to the connection share 112 of the file-based transport protocol, and the target virtual file system 116 may bind itself to the connection share 114 of the file-based transport protocol. The source virtual file system 108 may communicate with the target virtual file system 116 to establish connection/disconnection between connection shares.

When a request is initiated, the source virtual file system 108 may send out a replication request message to the connection share 114 of the file-based transport protocol, the replication request message including control data may be encoded into a binary data buffer of an I/O request packet (IRP). The source virtual file system 108 may encode 220 control data into the binary data buffer so that a target virtual file system 116 is able process a transmission of the file-based transport protocol. As an example, control data may be encoded within an offset and a length field of the IRP. The virtual file systems may be used to enable data transmitted over the file-based transport protocol to be properly processed for data replication. As an example, connection shares 112 and 114 may act as receivers of requests or responses. A sender of a response or request may initiate a direct call to a connection share on a remote machine using the file-based transport protocol. As the file-based transport protocol is a file level protocol, the file-based transport protocol is likely designed based on an idempotent nature of a file it is transmitting. Thus, during transmission between a source machine and a target machine, the file-based transport protocol may chunk buffer of the I/O request into smaller pieces and possibly retransmit same pieces of data multiple times. Therefore, the target virtual file system 116 needs to take further action to properly process a replication request.

In an example, the source virtual file system 108 encodes 220 the control data into an IRP offset and length field. This control data is used by the target virtual file system 116 to decode transmissions of the file-based transport protocol by applying retransmission logic and message reassembly logic. In an example where SMB is used as the file-based transport protocol, a buffer sent through SMB can be described as containing a 64-bit offset and 32-bit length which identifies which range of a file needs to be replaced by this buffer. The source virtual file system 108 may be used to encode control data into a higher 32 bits of file offset so that chunking and retransmission can be detected when a message is received at a target machine. With SMB, it is possible to chunk the message and send multiple buffers to a target. To be able to reassemble those buffers into a message, more specifically to know whether all parts of that message have been received, a total size of a message needs to be known. The target virtual file system 116 evaluates the control data to reassemble transmissions of the file-based transport protocol into a single replication message.

Of the upper 32 bits of control data (e.g., in a 64 bit SMB transmission), a bit range of 32 to 47 may be used for message reassembly logic. SMB transmission alone is not acceptable to send logs as a single message, since a typical log message is at least 2 MB in size. SMB guarantees that chunking size will be an integral multiple of 64 KB. In one example, a sender buffer is divided by 64 KB and a record number of such 64 KB chunks that will be send through SMB. By doing this, a bit range of 32 to 47 can describe up to 4 GB of message size. Based on identification of a minimal chunking unit defined in an SMB protocol, which is 64 KB, 16 bits is enough to define a length of a message. That is, 16 bits of control data are utilized to determine a total message length. Encoding 16 bits of message length into the control data informs the target virtual file system 116 of what length should be expected for a particular request message. In an example, the target virtual file system 116 may employ a counter to track how much data, belonging to a same request message, has been received. Message reassembly logic may be applied based on the SMB chunking

Of the upper 32 bits of control data (e.g., in a 64 bit SMB transmission), a bit range of 48 to 63 may be evaluated to detect retransmission, where this range is further divided into slot id and sequence id for the purpose of detecting retransmission. As 16 bits of control data are utilized to for evaluating total message length, another 16 bits (of the 32 bits of control data) may be allocated for data chunk retransmission. For example, 11 bits may be allocated to identification of a slot id and another 5 bits may be allocated to identification of the sequence ID. Data retransmission logic may be applied by the target virtual file system 116 to detect chunk retransmission. Each time a message is needed to deliver, a sender and a receiver will negotiate which slot this message will be delivered to and which sequence id that is accepted by the receiver. The target virtual file system 116 can evaluate whether the sequence ID does not match that of the sender. If this occurs, that message is treated as duplicate. Even though there are 11 bits used for slot id, SMB only allow highest bit of file offset to be 0. Therefore, 10 bits may be valid for a slot number. In one example, sliding windows may be utilized to process offset control data. For example, a slot id may correspond to a sliding window ID, and a sequence ID may correspond to a current window acceptable sequence ID. This can increase efficiency in processing of data.

Referring back to FIG. 2B, once a connection is established between a source virtual file system 108 and a target virtual file system 116 via the file-based transport protocol, the request message may be transmitted 224 via the file-based transport protocol to a target. The I/O request packets are received via the connection share 114 on the target and forwarded 226 to the target virtual file system 116. When the target virtual file system 116 receives the I/O request packets, transmission data is decoded 228 so that a received buffer is reassembled into a message that is processable by a replication engine. Decoding 228 may include applying the data retransmission logic and the message assembly logic discussed above.

The replication manager may use a replication engine to perform a write of the data to be replicated. After the write is completed, the target virtual file system 116 may create a response message to be sent back to the source virtual file system 108 and initiate a direct call to the connection share 112 of the file-based transport protocol of the source. In that example, a target machine will be the sender and a source machine will be the receiver. Thus, the response message is encoded 230 by the virtual file system 116 and attached to an I/O request packet to be forwarded 232 to the connection share 112 of the file-based transport protocol. The target virtual file system 116 will transmit 234 the IRP to a connection share 112 of the file-based transport protocol on a source device. That IRP will be forwarded 236 to a virtual file system 108 on the source for processing. The source virtual file system 108 may decode 238 the IRP so that the response can be processed.

Continuing an example where SMB is used as the file-based transport protocol, the virtual file systems of the source and target machines may be implemented to create an SMB share, manage connection establishment and close of the SMB share, provide connection loss detection, provide access control, and manage data transmission between an SMB share created on a source machine and an SMB share created on a target machine. The following are exemplary instructions/commands for SMB share creation and deletion:

### Connection Endpoint Creation and Destroy

1. Create virtual file system device for SMB share. Register virtual device with name “\Device\WvrTrnFs” by calling IoCreateDevice.
2. Create SMB share and virtual file to handle IO.
   a. Attach SHARE_INFO_503 to SERVER_REQUEST_PACKET and send FSCTL_SRV_NET_SHARE_ADD to SrvAdmin through NtFsControlFile.
   b. Those SMB share will be names as {ReplicaMemberGUID}. {ReplicationGroupGUID}
   c. Each SMB share contains a virtual file worked as the connection endpoint is named “SrEndpoint:007”
3. Delete SMB share.
   a. Send FSCTL_SRV_NET_SHARE_DEL to SrvAdmin through NtFsControlFile.
      As indicated above, a virtual file system may be usable to handle connection establishment/closing events, which are generally not handled by a file-based transport protocol such as SMB. Below are examples of exemplary instructions/commands for managing connection establishment and close when SMB is implemented as the file-based transport protocol:

Connection Establish and Close
1. Connect to SMB share
   Open a file handle to remote share's virtual file through sending IRP_MJ_CREATE to IoCreateFileEx given full network based path. In the EA buffer of this IRP, we fill in ReplicaMemberGUID and ReplicationGroupGUID of the local endpoint that allow remote TRN to connect back.
2. Pending IRP
   To detect connection failure, send IRP_MN_NOTIFY_CHANGE_DIRECTORY to the remote virtual file and this IRP will be pended until SMB connection between local and remote machine is lost.
   Send this IRP through the file handle opened in previous step.
3. Handle disconnect event
   There are multiple causes of disconnection:
   1) Close API is called.
   2) TRN detects connection loss
   3) Fail to send a message
   4) Connection is disconnected at remote end.
   Call first case as active disconnect, and all other cases passive disconnect. For active disconnect, SRT does not notify replication engine about disconnect event. For passive disconnect, SRT will invoke disconnect callback to notify replication engine.

With respect to connection loss detection, SMB does not have callback to notify the file handle on sender side when SMB connection behind this file handle is lost. Virtual file systems on a source and target may be implemented to a detect connection failure. The source virtual file system 108 may send an I/O request packet such as an IRP_MJ_DIRECTORY_CONTROL, through this file handle. When the target virtual file system 116 receives this IRP, it may return an I/O request packet such as STATUS_PENDING and pend the IRP until disconnection happens. If SMB connection is lost, all pending IRPs are still guaranteed to be completed by SMB. The source knows that a connection is lost when it gets a completion callback for this IRP.

Furthermore, a virtual file system may manage access control with respect to connections created via the file-based transport protocol. Below are examples of exemplary instructions/commands for managing access control when SMB is implemented as the file-based transport protocol:

Access Control
1. Security descriptor
   SD contains ACCESS_ALLOWED_ACEs for localAdmin, System, and all partner machine accounts (all machines involved in replication) with following access:
      GENERIC_READ
      GENERIC_WRITE
      STANDARD_RIGHTS_ALL
      SRVSVC_SHARE_CONNECT_ALL_ACCESS.
2. Create Security descriptor
   Fill SD in shi503 security descriptor field of SHARE_INFO_503 and send file system control FSCTL_SRV_NET_SHARE_ADD to SrvAdmin through NtFsControlFile
3. Modify Security descriptor
   Fill SD in shi505_security_descriptor field of SHARE_INFO_505 and send file system control FSCTL_SRV_NET_SHARE_SET_INFO to SrvAdmin through NtFsControlFile.

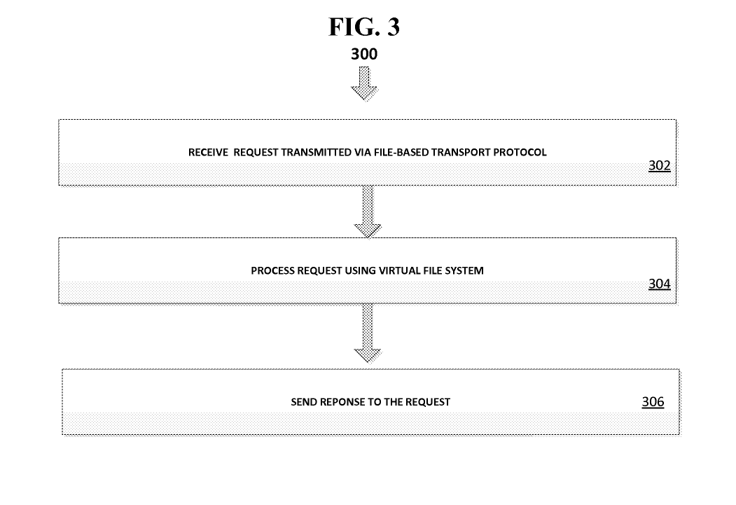

FIG. 3 illustrates an operational flow 300 for request and response processing. Flow 300 begins at operation 302, where a request sent from a first device to a second device is received using a file-based transport protocol as a transport service. In one example, a first device may be a source machine and a second device may be a target machine. However, the present disclosure is not limited to this example.

Flow 300 passes from operation 302 to operation 304, where a request is processed by a virtual file system. In one example, the virtual file system processing the request may be implementing a transport layer to interface with the file-based transport protocol. This enables the virtual file system to receive and evaluate transmissions of the file-based transport protocol.

At operation 306, a response to the request may be generated and sent to a device that initiated the request. The virtual file system may be used to generate the response and forward the response to the file-based transport protocol for transmission to the first device, for example which initiated the request.

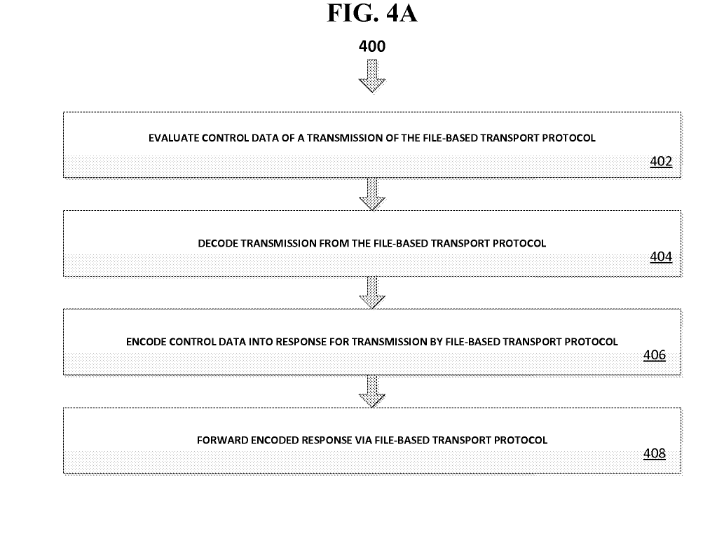

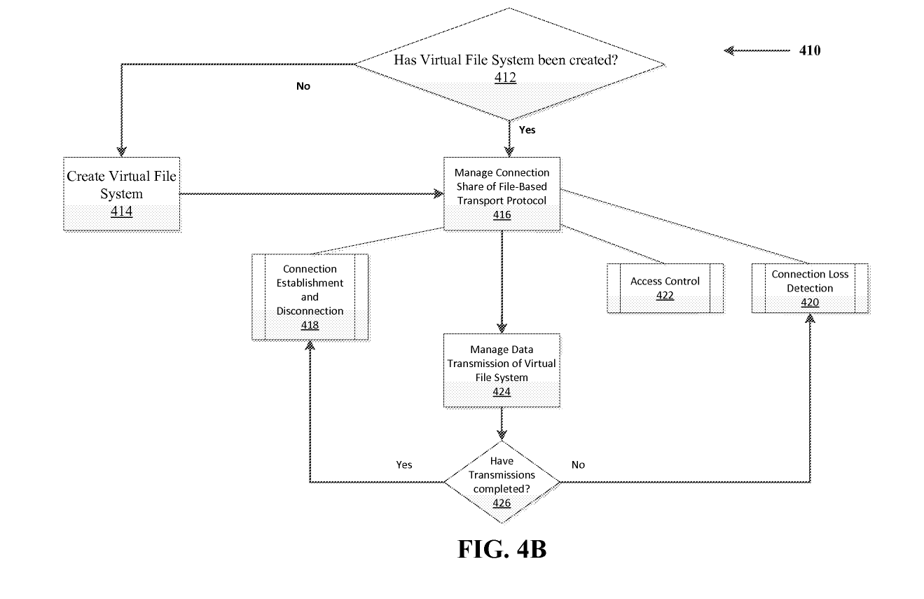

FIG. 4A is an operational flow 400 for examples of processing performed by a virtual file system. Flow 400 begins at operation 402, where control data of a transmission of the file-based transport protocol is evaluated. As described previously, control data may be encoded into a request packet so that a virtual file system is able to process a request transmitted by a file-based transport protocol. The virtual file system may evaluate the control data of each transmission from the file-based transport protocol, including an offset and a length field of an I/O request packet. As an example, the virtual file system may evaluate an upper thirty-two (32) bits of an offset for a transmission sent by the file-based transport protocol to detect chunk transferring and re-transmission.

Based on the evaluation of the control data, the virtual file system may move to operation 404, where transmissions of the file-based transport protocol are decoded. In decoding of the transmissions of the file-based transport protocol, the virtual file system may apply re-transmission detection logic and message re-assembly logic based to reassemble a message for processing by a replication engine of the virtual file system. This enables the request to be processed in a form that the replication engine can understand.

Flow 400 passes from operation 404 to operation 406, where the virtual file system may process a response to the request. In operation 406, the virtual file system may encode control data for the response into an input/output (I/O) request packet for transmission to a device which initiated the request. As an example, the virtual file system may encode control data into an upper thirty-two (32) bits of an offset of the I/O request packet for a transmission via the file-based transport protocol.

Afterwards, the encoded response is forwarded to the file-based transport protocol to transmit the response to another device. In an example, the device may be a device that initiated the request. However, in alternative examples, the requests and response may be notified to other devices as well.

FIG. 4B is an operational flow 410 of an example of a processing flow handled by a virtual file system. Flow 410 begins at block 412, where a device may determine if a virtual file system has been created. If a virtual file system is not yet created, creation 414 of the virtual file system occurs. As an example, a virtual file system may be created on each of a source device and a target device. If it is determined that a virtual file system already exists, flow 410 may proceed with management 416 of the virtual file system. A virtual file system may possess capability to manage: connection establishment and disconnection 418 with the file-based transport protocol, connection loss detection 420, access control 422, and data transmission 424.

Continuing on, flow 410 may determine 426 whether transmissions have been completed. Transmissions may include sending and receiving of requests as well as sending and receiving of responses. If it is determined that transmissions have not been completed, connection loss detection 420 may be implemented. If it is determined that transmissions have been completed, a connection with the file-based transport protocol may be temporarily disconnected or terminated.

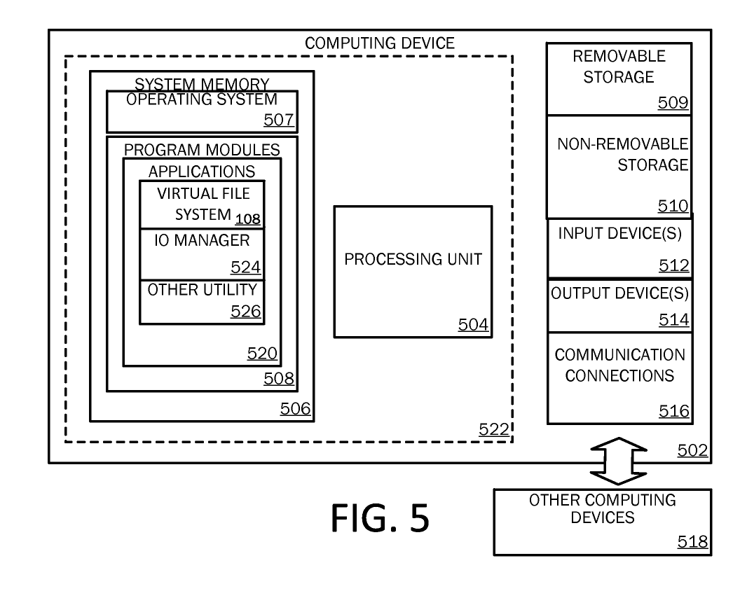

FIGS. 5-7 and the associated descriptions provide a discussion of a variety of operating environments in which examples of the invention may be practiced. However, the devices and systems illustrated and discussed with respect to FIGS. 5-7 are for purposes of example and illustration and are not limiting of a vast number of computing device configurations that may be utilized for practicing examples of the invention, described herein.

FIG. 5 is a block diagram illustrating physical components of a computing device 502, for example source machine 102 and a target machine 104 as described herein, with which examples of the present disclosure may be practiced. The computing device components described below may be suitable for the computing devices described above. In a basic configuration, the computing device 502 may include at least one processing unit 504 and a system memory 506. Depending on the configuration and type of computing device, the system memory 506 may comprise, but is not limited to, volatile storage (e.g., random access memory), non-volatile storage (e.g., read-only memory), flash memory, or any combination of such memories. The system memory 506 may include an operating system 507 and one or more program modules 508 suitable for running software applications 520 such as a virtual file system 108, IO manager 524, and other utility 526. The operating system 507, for example, may be suitable for controlling the operation of the computing device 502. Furthermore, examples of the invention may be practiced in conjunction with a graphics library, other operating systems, or any other application program and is not limited to any particular application or system. This basic configuration is illustrated in FIG. 5 by those components within a dashed line 522. The computing device 502 may have additional features or functionality. For example, the computing device 502 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 506. While executing on the processing unit 504, the program modules 508 (e.g., virtual file system 108, Input/Output (I/O) manager 524, and other utility 526) may perform processes including, but not limited to, one or more of the stages of the operational flow 400 illustrated in FIGS. 4A and 4B, for example. Other program modules that may be used in accordance with examples of the present invention may include electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 502 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 502 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 504 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 506, the removable storage device 509, and the non-removable storage device 510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 502. Any such computer storage media may be part of the computing device 502. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

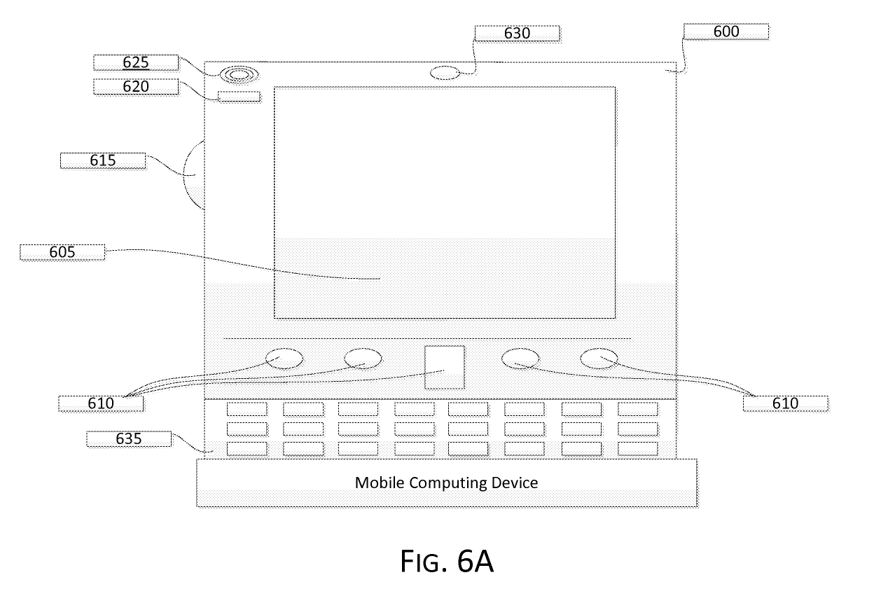

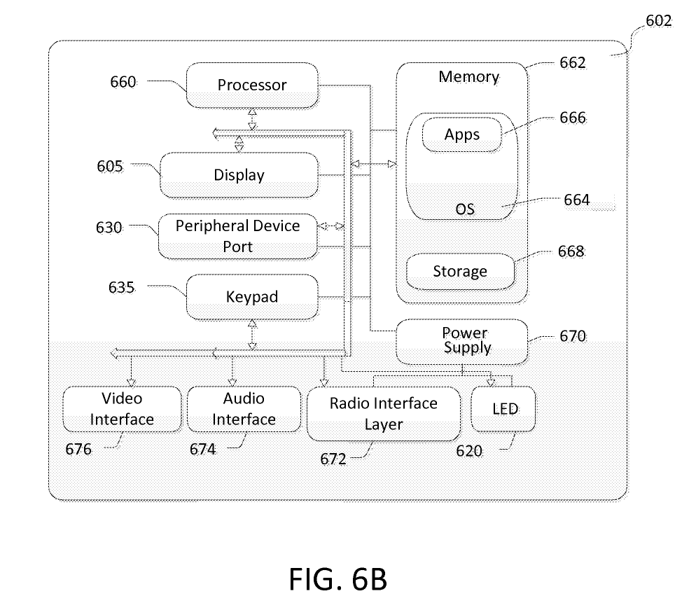

FIGS. 6A and 6B illustrate a mobile computing device 600, for example, a mobile telephone, a smart phone, a tablet personal computer, a laptop computer, and the like, with which examples of the invention may be practiced. For example, mobile computing device 600 may be used to implement source machine 102 or target machine 104. With reference to FIG. 6A, one example of a mobile computing device 600 for implementing the examples is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative examples, mobile computing device 600 may incorporate more or less input elements. For example, the display 605 may not be a touch screen in some examples. In yet another alternative example, the mobile computing device 600 is a portable phone system, such as a cellular phone. The mobile computing device 600 may also include an optional keypad 635. Optional keypad 635 may be a physical keypad or a “soft” keypad generated on the touch screen display. In various examples, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 can incorporate a system (i.e., an architecture) 602 to implement some examples. In one examples, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including virtual file system 108, IO manager 524, and other utility 526 described herein.

The system 602 has a power supply 670, which may be implemented as one or more batteries. The power supply 670 might further include an external power source, such as an AC adapter or a powered docking cradle that supplements or recharges the batteries.

The system 602 may include peripheral device port 678 that performs the function of facilitating connectivity between system 602 and one or more peripheral devices. Transmissions to and from the peripheral device port 672 are conducted under control of the operating system 664. In other words, communications received by the peripheral device port 678 may be disseminated to the application programs 666 via the operating system 664, and vice versa.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with examples of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

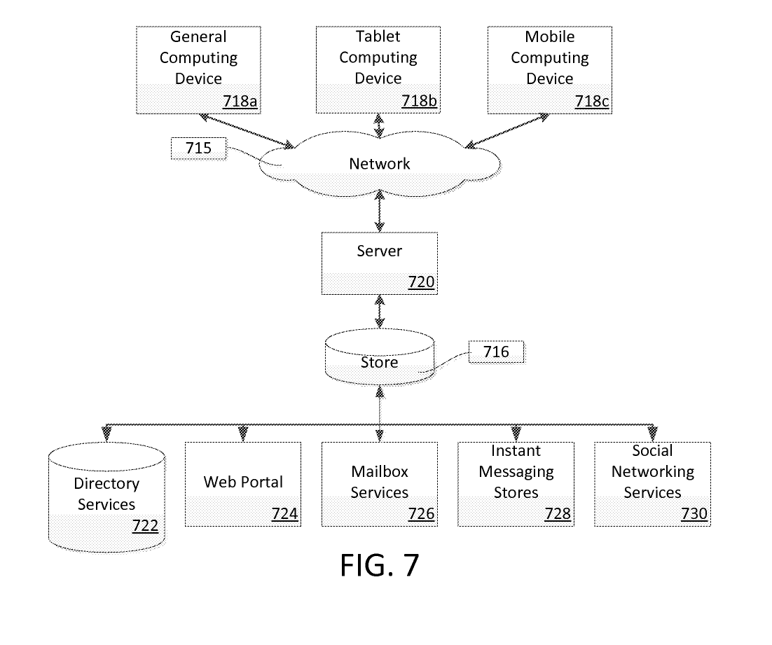

FIG. 7 illustrates one example of the architecture of a system for providing an application that reliably accesses target data on a storage system and handles communication failures to one or more client devices, as described above. Target data accessed, interacted with, or edited in association with virtual file system 108, IO manager 524, other utility 526, and storage (e.g., storage 110 and storage 118) may be stored in different communication channels or other storage types. For example, various documents may be stored using a directory service 722, a web portal 724, a mailbox service 726, an instant messaging store 728, or a social networking site 730, virtual file system 108, IO manager 524, other utility 526, and storage systems may use any of these types of systems or the like for enabling data utilization, as described herein. A server 720 may provide storage system for use by a client operating on general computing device 502 and mobile device(s) 600 through network 715. By way of example, network 715 may comprise the Internet or any other type of local or wide area network, and client nodes may be implemented as a computing device 502 embodied in a personal computer, a tablet computing device, and/or by a mobile computing device 600 (e.g., a smart phone). Any of these examples of the client computing device 502 or 600 may obtain content from the store 716.

According to one example, a request that is sent from a first device may be received at a second device using a file-based transport protocol as a transport service. In an example, the request may be a data replication request for a remote write of a log file written into a data storage of the first device. The request may be processed by the second device using a virtual file system, which implements a transport layer to interface with the file-based transport protocol. The transport layer of the virtual file system may be utilized to receive, evaluate and process transmissions from the file-based transport protocol. Evaluation of transmissions may include evaluating control data of each transmission from the file-based transport protocol. As an example, the transport layer may evaluate an upper thirty-two (32) bits of an offset for a transmission sent by the file-based transport protocol to detect chunk transferring and data re-transmission. The transport layer of the virtual file system may receive a plurality of transmissions from the file-based transport protocol, and decode the transmissions by implementing re-transmission detection logic and message re-assembly logic to process the plurality of transmissions of the file-based transport protocol as a single message. A response may be processed by the virtual file system where the transport layer encodes control data for the response into an input/output (I/O) request packet for transmission via the file-based transport protocol. In encoding the response, control data may be encoded into an upper thirty-two (32) bits of an offset of the I/O request packet for a transmission via the file-based transport protocol. The virtual file system may forward a response to the file-based transport protocol for transmission to the first device. As an example, the file-based transport protocol may be an iteration of Server Message Block (SMB).

In another example, the transport layer of the virtual file system communicates with the file-based transport protocol and a replication engine included in the virtual file system, to process a request. The replication engine may include a replication manager for handling replication requests. The transport layer of the virtual file system may be used to decode the reassembled request by applying data retransmission logic and message assembly logic. The decoded request may be sent to the replication manager for processing. The transport layer may receive a response from the replication manager and encode control data for the response into an input/output (I/O) response packet. The encoded response packet is then and forwarded via the file-based transport protocol.

In another example, an application may be implemented to create a virtual file system on a device. The virtual file system may be used to manage: establishment/disconnection of a connection share of a file-based transport protocol, access control with respect to the connection share, connection loss detection of the connection share, and data transmission to and from the device.

In yet another example, a remote write request is sent from a source device to a target device using a file-based transport protocol as a transport service. The remote write request is processed using a virtual file system, the virtual file system implementing a transport layer to interface with the file-based transport protocol for receiving and evaluating transmissions of the file-based transport protocol. The transport layer may be used to decode control data encoded in an offset and length field of an input/output (I/O) request packet for replication request processing. The decoding may include implementing re-transmission detection logic and message re-assembly logic to process the plurality of transmissions of the file-based transport protocol as a single message. In the decoding, an upper thirty-two (32) bits of an offset for a transmission sent by the file-based transport protocol may be evaluated to detect chunk transferring and data re-transmission. A response is sent, wherein the virtual file system forwards the response to the file-based transport protocol for transmission. Control data may be encoded into an offset and length field of an input/output (I/O) response packet, and sent via the file-based transport protocol. The virtual file system may be used to manage: establishment/disconnection of a connection share of a file-based transport protocol, access control with respect to the connection share, connection loss detection of the connection share, and data transmission to and from a device. As an example, the file-based transport protocol may be an iteration of Server Message Block (SMB).

In an additional example, a computer system may be implemented that includes at least one device for storage replication. The device may be able to send and receive requests and send and receive responses to a request via a file-based transport protocol. The device may be configured to process requests and responses using a virtual file system. The virtual file system may include a transport layer to interface with the file-based protocol for processing data transmitted via the file-based transport protocol. The transport layer of the virtual file system may be configured to encode and decode offset data, including data for applying re-transmission logic and message reassembly logic, into a transmission of the file-based transport protocol. The device may encode the data for applying re-transmission logic and message re-assembly logic into an upper thirty-two (32) bits of the offset when sending a request or response, and decode data for applying re-transmission logic and message re-assembly logic from the upper 32 bits of the offset when receiving a request or response.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While example examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving a request sent from a first device at a second device using a file-based transport protocol as a transport service;
processing the request using a virtual file system, the virtual file system implementing a transport layer to interface with the file-based transport protocol to receive and evaluate transmissions of the file-based transport protocol; and
sending a response to the request, wherein the virtual file system forwards the response to the file-based transport protocol for transmission to the first device.

2. The method according to claim 1, wherein the transport layer of the virtual file system receives a plurality of transmissions from the file-based transport protocol, and decodes the transmissions by implementing re-transmission detection logic and message re-assembly logic to process the plurality of transmissions of the file-based transport protocol as a single message.

3. The method according to claim 2, wherein evaluation of the transmissions of the file-based transport protocol comprises evaluating control data of each transmission from the file-based transport protocol and applying the re-transmission detection logic and the message re-assembly logic based on evaluating the control data.

4. The method according to claim 3, wherein evaluating the control data comprises evaluating an upper thirty-two (32) bits of an offset for a transmission sent by the file-based transport protocol to detect chunk transferring and re-transmission.

5. The method according to claim 1, wherein evaluation of the transmissions of the file-based transport protocol comprise decoding control data encoded in an offset and length field of an input/output (I/O) request packet transmitted via the file-based transport protocol.

6. The method according to claim 1, wherein the request is a data replication request for a remote write of a log file written into a data storage of the first device.

7. The method according to claim 1, wherein the transport layer of the virtual file system encodes control data for the response into an input/output (I/O) request packet for transmission to the first device by the file-based transport protocol.

8. The method according to claim 7, wherein the control data is encoded into an upper thirty-two (32) bits of an offset of the I/O request packet for a transmission via the file-based transport protocol.

9. The method according to claim 1, wherein the transport layer of the virtual file system communicates with the file-based transport protocol and a replication engine included in the virtual file system, to process the request.

10. The method according to claim 9, wherein the replication engine includes a replication manager, and
wherein the transport layer of the virtual file system:
decodes the reassembled request by applying data retransmission logic and message assembly logic,
sends the decoded request to the replication manager for processing,
receives a response from the replication manager,
encodes control data for the response into an input/output (I/O) response packet, and
forwards the encoded I/O response packet to the file-based transport protocol for transmission to the first device.

11. The method according to claim 1, wherein the file-based transport protocol is Server Message Block (SMB).

12. The method according to claim 1, further comprising:
creating the virtual file system on the second device; and
managing, using the virtual file system:
a connection share of the file-based transport protocol on the second device,
access control with respect to the connection share,
connection loss detection of the connection share, and
data received and transmitted from the virtual file system.

13. A computer-readable storage medium including executable instructions, which when executed on a computer, cause the computer to perform a process comprising:
receiving a remote write request sent from a source device to a target device using a file-based transport protocol as a transport service;
processing the remote write request using a virtual file system, the virtual file system implementing a transport layer to interface with the file-based transport protocol for receiving and evaluating transmissions of the file-based transport protocol; and
sending a response to the request, wherein the virtual file system forwards the response to the file-based transport protocol for transmission to the source device.

14. The computer-readable storage medium according to claim 12, wherein when the executable instructions are executed by the computer, the process further comprising:
creating the virtual file system on the second device; and
managing, using the virtual file system:
a connection share of the file-based transport protocol on the second device,
access control with respect to the connection share,
connection loss detection of the connection share, and
data received and transmitted from the virtual file system.

15. The computer-readable storage medium according to claim 12, wherein the file-based transport protocol is Server Message Block (SMB).

16. The computer-readable storage medium according to claim 12, wherein when the executable instructions are executed by the computer, the process further comprising:
decoding control data encoded in an offset and length field of an input/output (I/O) request packet transmitted via the file-based transport protocol,
wherein the decoding comprises implementing re-transmission detection logic and message re-assembly logic to process the plurality of transmissions of the file-based transport protocol as a single message.

17. The computer-readable storage medium according to claim 16, wherein the decoding comprises evaluating an upper thirty-two (32) bits of an offset for a transmission sent by the file-based transport protocol to detect chunk transferring and re-transmission.

18. The computer-readable storage medium according to claim 13, wherein sending of the response comprises encoding control data for the response into an offset and length field of an input/output (I/O) response packet, and sending, via the file-based transport protocol, the I/O response packet to the source device.

19. A computer system comprising:
at least one device for storage replication that is able send and receive requests and send and receive responses to a request via a file-based transport protocol,
wherein the device is configured to process requests and responses using a virtual file system, the virtual file system including a transport layer to interface with the file-based protocol for processing data transmitted via the file-based transport protocol, wherein the transport layer of the virtual file system is configured to encode and decode offset data, including data for applying re-transmission logic and message reassembly logic, into a transmission of the file-based transport protocol.

20. The computer system according to claim 19, wherein the device encodes the data for applying re-transmission logic and message re-assembly logic into an upper thirty-two (32) bits of the offset when sending a request or response, and decodes data for applying re-transmission logic and message re-assembly logic from the upper 32 bits of the offset when receiving a request or response.
